(19) United States
(12) Patent Application Publication
(10) Pub. No.: US 2012/0139724 A1
(43) Pub. Date: Jun. 7, 2012

(54) Area Identification and Area Definition by Utilizing RF Technology

(75) Inventors: Jorma Olavi Keinänen, Klaukkala (FI); Sauli Hepo-Oja, Helsinki (FI)

(73) Assignees: Jorma Olavi Keinanen, Klaukkala (FI); Sauli Hepo-Oja, Helsinki (FI); Marja-Liisa Keinanen, Klaukkala (FI)

(21) Appl. No.: 13/255,035

(22) PCT Filed: Feb. 26, 2010
(86) PCT No.: PCT/FI10/50155

§ 371 Date: Nov. 7, 2011

(30) Foreign Application Priority Data
Mar. 6, 2009 (FI) 20095222
Feb. 26, 2010 (FI) PCT/FI2010/050155

(51) Int. Cl. G08B 1/08

(52) U.S. Cl. 340/539.13

(57) ABSTRACT

The object of the invention is a positioning system for positioning at least one mobile device (100) by utilizing radio frequency technology on a positioning area of said system. The system comprises at least one stationary base station (106), i.e. a transceiver, which comprises at least one antenna (102, 104) for transmitting signals comprising at least position information to at least one mobile device (100), which comprises at least one antenna (108) for receiving said signals. The system comprises as said mobile device (100) an electronics unit for measuring at least intensities of received signals and for processing and storing received signals, which comprises position information, and for transmitting signals, which comprise at least position information, through its antenna (108) automatically and/or upon request to said at least one stationary base station (106).

### AREA OF THE INVENTION

For example identification of position of dementia patients on a hospital area and also outside the hospital area is important, because is the matter of patient's own safety that patient doesn't have a possibility to move too far from patient's allowed movement area.

### STATE OF THE ART

On the market have been for a long time systems, which are based on radio frequency technology, i.e. rf (radio frequencies) technology, in which systems a mobile device obtains area information for example electro magnetically, such as for example in document WO9928881 A1 “Person locating system”, where an area is defined by using a low frequency signal, which does not have a long effect distance. The mobile device transmits an alarm by radio frequency signal, when it enters to an effect area of said fields. In said system the mobile device itself does not carry with any area specific code. In different prior art solutions the area information is stored to tag on the basis of the antenna, from which the tag has received the latest signal.

On the market have also been known solutions, which are based on traditional RFID-technology (Radio Frequency IDentification), where a fixed device detects a mobile device when it enters to an antenna field. A problem in traditional RFID solutions has been for example in relation to movement direction and area exchange, that antennas, which represent different areas, have needed long distances between them in order to define different areas, so that the latest signal surely is from the nearest antenna, when exit is happening from the one in question defined area. It has been almost impossible to define a right area on interface areas between the antennas, because then signals are received from all or almost all antennas on the interface areas. Then even in a stationary position an area may change all the time when new signals from different antennas are received.

The positioning systems on the market are based typically on base station network, and usually in positioning is applied so called three point measurement, which demands at least three base stations, which makes them expensive solutions to small and cellular places.

In some WLAN (Wireless Local Area Network)/WiFi-based (trademark of the Wi-Fi Alliance) rf systems positioning is based on three point measurement made by base stations on the basis of RSSI (Received Signal Strength Indication) measurement of received signals in rf far field, which measurement is based on rf signal transmitted by the mobile device, and thus this consumes its batteries. Said consuming is big already for the reason, that WLAN/WiFi represents heavy technology for implementing a mobile device, because it is originally a solution to data transfer. And because of far field it does not allow an accurate area definition.

In some WLAN/Wifi based rf systems, which are presented for example in patent documents U.S. Pat. No. 7,312,752 (Awarepoint Corporation) and U.S. Pat. No. 7,042,391 (Xerox Corporation), the positioning is based on beacon signal intensity measurements made by a mobile device in rf far field, when batteries of the mobile device are consumed, when it waits actively radio on the beacon signals, which are not transmitted continuously but between certain time gaps.

### BRIEF DESCRIPTION OF THE INVENTION

The object of the invention is a positioning system, which accomplishes a positioning of an object, which changes its position, i.e. a mobile device, with a good reliability so that the mobile device itself performs the needed measurement and performs an rf frequency transmission seldom thus achieving a small power consumption. This is achieved by a positioning system for positioning at least one mobile device by utilizing radio frequency technology on a positioning area of said system. The system comprises at least one stationary base station, i.e. a transceiver, which comprises at least one antenna for transmitting signals comprising at least position information to at least one mobile device, which position information of the signals comprises information on an effect area of the antenna by using certain transmit power, which effect area of the antenna is dividable on two or more sections based on power measurement, calculation and/or judging, and said mobile device comprises at least one antenna for receiving said signals, and which system comprises as said mobile device an electronics unit for measuring at least intensities of received signals and for processing and storing received signals, which comprises position information, and for transmitting signals, which comprise at least position information, through its antenna automatically and/or upon request to said at least one stationary base station.

The invention is based on that the system comprises at least one stationary fixed base station, i.e. a transceiver, which comprises at least one antenna for transmitting signals comprising at least position information to at least one electronics unit, for measuring at least intensities of received signals and for processing and storing received signals, which comprises position information, and for transmitting signals, which comprise at least position information, through its antenna automatically and/or upon request to said at least one stationary base station.

This embodiment according to the invention can operate in minimum as cell on the area of one base station, because the base station transmits through one or more of its antennas information on its effect area on certain transmit power to a tag. Thus in positioning is not needed a database, and an external system arrangement, which performs calculation operations, because the tag itself measures signal intensity, and judges its position in real time on the basis of the information received from the antenna.

The benefit of the invention is that it makes possible well performing positioning of an object, which changes its position, i.e. a mobile device, with a good reliability so that the mobile device itself performs the needed measurements and performs an rf frequency transmission seldom thus achieving a small power consumption.

### LIST OF FIGURES

FIG. 1 describes one embodiment according to the invention.

### DETAILED DESCRIPTION OF THE INVENTION

According to the implementation of the invention is carried out positioning of at least one mobile electronics unit by utilizing radio frequency technology in the region of the system according to the invention. The system comprises at least one stationary transceiver, i.e. base station, which comprises at least one antenna transmitting signals containing at least position information to one or more mobile electronics unit, which comprises at least one antenna to receive said signals. The electronics unit comprises a measurement unit for performing at least intensity measurements of the received signals. The electronics unit comprises a processor, such as for example a microcontroller, for processing and storing the received signals containing position information. The electronics unit comprises a radio unit for transmitting signals containing at least position information via an antenna of the radio unit to the at least one stationary base station. When there are more than one base stations, they can also operate as parts of the telecommunication network. The stationary base station and antenna may also be part of a larger moving entity, and on a territory of the entity is carried out positioning in accordance to the invention.

The system may comprise more than one stationary base station as network parts and said at least one base station is the part of a larger moving entity, and on the territory of the entity is carried out positioning. The mobile device of the system comprises an electronics unit for processing received signals containing position information by taking into account the number of signals per time unit and, where appropriate, by utilizing the previous stored information on these signals. The spatial data contained in the signals comprises at least information on an effect area of the antenna in a given transmission power level, and the effect area of the antenna can be divided to one or more parts on the basis of the power measurement.

A mobile device may include electronics unit and at least one antenna for receiving signals containing position information by a radio unit in the electronics unit, and said electronics unit also comprises a measurement unit for measuring signal levels in order to form measurement information, and a processor for processing said information by comparing mathematical values calculated from signals received by at least one antenna to values, which were calculated earlier, and by judging, and/or by calculating by using at least one algorithm, in which area and/or in which part of the antenna area the electronics unit is at different time moments, said antenna transmitting signals containing position information.

The system may comprise at least one transceiver, and at least one antenna for transmitting additional information needed by the electronics unit, and one or more radio unit of the mobile electronics units for receiving said signals comprising additional information, and one or more processor of mobile electronics unit for processing said additional information to calculate and/or to judge the more precise position of the electronics unit.

The system may comprise mobile electronics unit for processing received signals containing position information by storing in the learning mode signal values and/or levels, at least values and/or levels of interface between regions, which values exceed a determined value and/or level. The system may comprise a mobile electronics unit to implement a region exchange function by failing to accept the calculation of successive new signals having almost the same level while the system is standing still, which is noticed, when a movement detection part of the electronics unit has not performed an announcement of a movement of the object. The system may also comprise a mobile electronics unit for performing base station tasks.

In an implementation according to the invention the mobile device has the nature of a RFID tag, which does not need in its RF receiver a power-consuming active preamplifier, but it works in the RF near field based on a passive signal detection, and it connects to an active mode, when it comes to an area, which has sufficiently strong signal, when it preferably, without a waiting period can immediately measure the coming signal, and still without a load of the preamplifier, (which load could be for example, about 10 mA). This is possible because the RFID antenna can transmit up to 2 W power, and such a high transmit power also eliminates effects of possible other RF transmissions on measurement accuracy of the signal intensity, which the tag has received. By this way can be achieved in a small area a highly accurate area distinction, as compared especially to prior art solutions operating in the rf far field. In this embodiment antennas can be located even very close to one another.

Presented below, with at least partially referenced to 1, are features of the invention to be utilized in the preferred embodiments of the invention.

Electronics unit 100 is preferably radio-frequency tag or radio frequency identification based transceiver, which comprises at least one antenna 108. Positioning system comprises at least one transceiver i.e. base station 106, to which is integrated or connected antennas 102, 104, and mobile devices 100 i.e. tags, which communicate with base stations and receive and transmit RF signals through their antennas 108. It can be also noted that tag, in accordance with the invention, does not necessarily mean any standard compliant device, but a mobile device which is attached to a monitored object, such as for example, a patient of the hospital. Both the base station 106 and tag 100 can operate, if necessary, as bidirectional rf devices, which comprise transceivers, i.e. devices capable of performing as well the receiving of signals as the transmission of signals.

By placing one or more of the antennas 102, 104 the area is divided into one or more sections, and the aim is that these sections are distinguishable (having a clear interface between one another). A mobile device 100 or tag knows on the basis of RF signals transmitted by one or more base stations 106, which area is the one in question at different time points. The moving TAG calculates and/or judges itself, the area in which it currently is, even though it receives at the same time signals from various antennas 102, 104 i.e. from a number of different areas. Judging and/or calculation is based on the individual ID data (area nro1/area nro2/ . . . /area No. n) transmitted by the antennas, on the intensity of rf signal and/or on the number of signals/time unit as well as on history data. Antennas can transmit additional information to the TAG, such as antenna specified threshold values and/or setting values, based on which the mobile device will be better able to calculate and/or judge its position. Additional information may at least be in the form, that operation instructions are set to the tag by telling it that when it enters this area, it must transmit a specific code and/or information, if it is required by the configuration of the tag.

In embodiments according to the invention the positioning is carried out in such a way that a tag 100 moving around an interface receives signals from one or more of the antennas, and the tag measures itself intensity of these signals and/or counts the signal amount per time unit and calculates and/or judges by using different algorithms, on which antenna 102, 104 area the tag locates at different time moments, said antennas 102, 14 transmitting position signals. The tag comprises area and/or other information, and notifies it automatically or upon request depending on the application. A decisive advantage is given by the fact that the mobile device 100 itself measures the signal intensity and processes it mathematically and logically so, that it is comparable also to signals from other antennas. Thus an interface is also configurable and modifiable by software. These facts make possible that areal segmentation operates reliably even in a very small space, because antenna signals may extend to each other's areas. Requirements for antenna directions may therefore be less stringent as in previous solutions have been required.

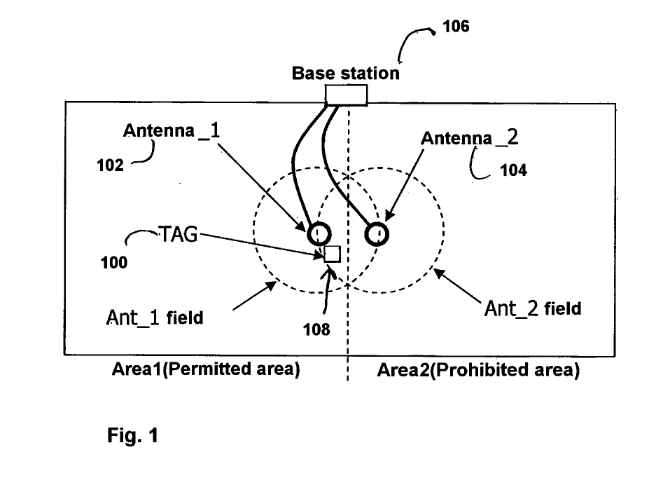

By referring to FIG. 1 as one application example is presented a manhole, where inside “area1 (permitted area)” one can move freely, but as soon as the transition from one side of the interface to other “area2 (prohibited area)”, transmits a mobile device (TAG) 100 automatically a notification of overrunning. In said FIGURE antennas 102, 104 are on the ceiling, but in some applications, they may also locate on the wall so that the beams are horizontally or at an angle. Also they can be located under the floor. Also all intermediate forms of these installation methods are suitable for methods according to the invention. Sizes of the areas can be broadened by increasing amount of antennas.

In an example according to the preferred embodiment of the invention, both the electronics units of the base station 106 and tag 100 comprises as components at least rf transceiver circuit and microcontroller. Additionally, the base station comprises a power component and an RF amplifier. Additionally, the tag comprises analog circuits for signal processing and an A-D converter and a movement detector, such as for example an acceleration sensor. Some of the components can be integrated to the same IC circuitry. Components can also be freely commercially available standard components.

The interface may be indicated to the mobile device 100 by antenna specific control values transmitted from the base station 106 and/or the mobile device can be taught to identify the interface by setting the mobile device in a learning mode and by frog-marching the mobile device around the interface (or by moving otherwise according to the application), for example, “on the permitted side (area1)”; when it collects to its memory from the antenna 102, 104 signals and/or transmits to the base station 106 values, which are allowed in these regions and/or the indicative limit values. The learning mode can be automatic and/or people demanding teaching situation. In this learning mode, thus obtained antenna specific threshold values and/or setting values are stored at least to the base station 106 memory, and after the learning mode, the base station will transmits them to other TAGs 100 at appropriate time moments as additional antenna specific information.

At the end of the learning mode, values and/or levels are stored in the said the base station 106 for the purpose that later after self received these information, which were earlier stored in said base station 106 in the learning mode at this stage as additional information from said base station, and when the tag 100 enters again to the area of said base station for example from an area of an another base station, the tag can determine its position more precisely. In the learning mode is formed information, which comprise at least allowed threshold values and/or indicative threshold values of the area. After the learning mode the base station transmits said information, formed in the learning mode, to other tags at appropriate time moments as additional information or as antenna 102, 104 specific information. Tag can also carry said learnt information. Instead of tag, the base station can be taught by a separate device for this meaning.

Although the invention has been presented in reference to the attached figures and specification, the invention is by no means limited to those as the invention is subject to variations within the scope allowed for by the claims.

1. A positioning system for positioning at least one mobile device (100) by utilizing radio frequency technology on a positioning area of said system, wherein the system comprises at least one stationary base station (106), i.e. a transceiver, which comprises at least one antenna (102, 104) for transmitting signals comprising at least position information to at least one mobile device (100), which position information of the signals comprises information on an effect area of the antenna (102, 104) by using certain transmit power, which effect area of the antenna is dividable on two or more sections based on power measurement, calculation and/or judging, and said mobile device (100) comprises at least one antenna (108) for receiving said signals, and which system comprises as said mobile device (100) an electronics unit for measuring at least intensities of received signals and for processing and storing received signals, which comprises position information, and for transmitting signals, which comprise at least position information, through its antenna (108) automatically and/or upon request to said at least one stationary base station 106.

2. A positioning system in accordance to claim 1, wherein the system comprises at least one stationary base station (106) as network parts and said at least one base station (106) is a part of a larger moving entity, and on the territory of the entity is carried out positioning.

3. A positioning system in accordance to claim 1, wherein the moving electronics unit (100) is a radio frequency tag.

4. A positioning system in accordance to claim 1, wherein the system comprises a moving electronics unit (100) for processing received signals containing position information by taking into account the number of signals per time unit and, where appropriate, by utilizing previous stored information on these signals.

5. A positioning system in accordance to claim 1, wherein the system comprises an electronics unit (100) and at least one antenna (108) for receiving signals containing position information by a radio unit in the electronics unit, and said electronics unit (100) comprises a measurement unit for measuring signal levels in order to form measurement information, and a processor for processing said information by comparing mathematical values calculated from signals received by at least one antenna to values, which were calculated earlier, and by judging, and/or by calculating by using at least one algorithm, in which antenna area and/or in which part of the antenna area the electronics unit is at different time moments, said antenna transmitting signals containing position information.

6. A positioning system in accordance to claim 1, wherein the system comprises at least one transceiver (106), and at least one antenna (102, 104) for transmitting additional information needed by the mobile electronics unit (100), and one or more mobile electronics units (100) for receiving said signals comprising additional information, and for processing said additional information to calculate and/or to judge the more precise position of the electronics unit (100).

7. A positioning system in accordance to claim 1, wherein the system comprises a mobile electronics unit (100) for processing received signals containing position information by storing in the learning mode signal values and/or levels, at least values and/or levels of interface between areas, which values exceed or go below a determined value and/or level.

8. A positioning system in accordance to claim 1, wherein the system comprises a mobile electronics unit (100) to implement an area exchange function by failing to accept the calculation of successive new signals having almost the same level while the system is standing still, which is noticed, when a movement detection part of the electronics unit (100) has not performed an announcement of a movement of the object.

9. A positioning system in accordance to claim 1, wherein the system comprises a mobile electronics unit (100) for performing similar tasks as base station (106) tasks.
